(19) United States
(12) Patent Application Publication
(10) Pub. No.: US 2017/0332541 A1
(43) Pub. Date: Nov. 23, 2017

(54) Garden-Implement-Handle Device

(71) Applicant: Robert Bosch GmbH, Stuttgart (DE)

(72) Inventors: Arpad Gyuricza, Stowmarket (GB); Endre Zador, Ipswich, Suffolk (County) (GB)

(21) Appl. No.: 15/533,791

(22) PCT Filed: Nov. 9, 2015
(86) PCT No.: PCT/EP2015/076009

§ 371 Date: Jun. 7, 2017

(30) Foreign Application Priority Data
Dec. 9, 2014 (DE) 10 2014 225 326.8
Dec. 9, 2014 (DE) 10 2014 225 329.2
Dec. 17, 2014 (EP) 14198441.9

(51) Int. Cl. A01B 1/22; B25G 1/04; A01D 101/00; A01B 1/00; A01D 11/00

(52) U.S. Cl. CPC A01B 1/227; B25G 1/04; A01D 11/00; A01B 1/00; A01D 2101/00

(57) ABSTRACT

A system includes a garden implement handle device that is disposed on a garden care machine. The garden implement handle device has an operating unit. The operating unit has an operating element that is configured for actuation by an operator. The garden implement handle device has a further operating element that is configured for actuation by the operator. The system further includes an electronics unit configured to switch an energy supply of a drive unit based on the actuation of the operating element and an actuation of the further operating element. The operating element and/or the further operating element are a touch-sensitive electronic operating element.

### PRIOR ART

There has already been proposed a system having at least one garden implement handle device that can be disposed on a garden care machine and that comprises at least one operating unit, which has at least one operating element that can be actuated by an operator, and at least one further operating element that can be actuated by an operator, and having at least one electronics unit, which is designed, at least, to switch at least one energy supply of a drive unit at least in dependence on an actuation of the operating element and of the further operating element.

### DISCLOSURE OF THE INVENTION

The invention is based on a system having at least one garden implement handle device that can be disposed on a garden care machine and that comprises at least one operating unit, which has at least one operating element that can be actuated by an operator, and at least one further operating element that can be actuated by an operator, and having at least one electronics unit, which is designed, at least, to switch at least one energy supply of a drive unit at least in dependence on an actuation of the operating element and of the further operating element.

It is proposed that the operating element and/or the further operating element are/is realized as an electronic operating element realized so as to be touch-sensitive. Preferably, the garden implement handle device is realized, at least substantially, in the form of a rod. Particularly preferably, the garden implement handle device is disposed in a removable manner, in particular a fixable manner, on a garden care machine. Preferably, an actuation of the operating element and/or of the further operating element can be interrogated and/or sensed electronically by means of the electronics unit. A “garden implement handle device” in this context is to be understood to mean, in particular, a handle device and/or an ancillary handle device for a garden care machine. Preferably, it is to be understood to mean, in particular, a device having at least one handle that can be disposed on a garden care machine. Preferably, the device is designed to provide a handle and/or an ancillary handle on a garden care machine. Particularly preferably, the garden implement handle device is realized such that it is independent of a garden care machine. The garden care machine may be realizes as a lawnmower, as a lawn trimmer, as a hedge trimmer, as a grass cutter, as a chainsaw, as a pruning saw, as a garden claw, or as another motor-operated garden care machine considered appropriate by persons skilled in the art.

An “operating unit” is to be understood here to mean, in particular, a unit having at least one component, in particular the operating element and/or the further operating element, that can be actuated directly by an operator, and which is designed to influence and/or change a process and/or a state of a unit coupled to the operating unit as a result of an actuation and/or an input of parameters. An “operating element” is to be understood to mean, in particular, an element designed to receive an input quantity from an operator in an operating operation and, in particular, to be contacted directly by an operator, wherein touching of the operating element is sensed, and/or an actuating force exerted upon the operating element is sensed and transferred for the purpose of controlling a unit.

An “electronics unit” is to be understood to mean, in particular, a unit having at least one control electronics. A “control electronics” is to be understood to mean, in particular, a unit having a processor unit and having a storage unit, and having an operating program stored in the storage unit. “Designed” is to be understood to mean, in particular, specially configured, specially programmed and/or specially equipped. That an element and/or a unit are/is designed for a particular function is to be understood to mean, in particular, that the element and/or the unit fulfill/fulfills and/or execute/executes this particular function in at least one application state and/or operating state.

That “the garden implement handle device is realized, at least substantially, in the form of a rod” in this context is to be understood to mean, in particular, that the garden implement handle device has a main body having a main extent that is substantially greater than an extent of the main body perpendicular to a direction of main extent. Preferably, it is to be understood to mean, in particular, that a smallest geometric cuboid that only just fully encloses the garden implement handle device has a longest side edge that is substantially greater than a second-longest side edge. “Substantially greater” in this case is to be understood to mean, in particular, at least twice, preferably at least four times, and particularly preferably at least six times as great. A “direction of main extent” of a unit is to be understood to mean, in particular, a direction parallel to a longest side edge of a least geometric cuboid that only just fully encloses the unit.

Preferably, the operating element and/or the further operating element comprises/comprises a switching contact that can be switched as a result of an actuation of the operating element. The switching contact of the respective operating element is preferably designed to generate a switching signal, realized as an electrical characteristic quantity, in dependence on a touch on the respective operating element. The switching signal can preferably be transmitted to the electronic unit, and evaluated and processed further by the latter. The operating element and/or the further operating element are/is preferably realized as resistive, capacitive or inductive operating elements/a resistive, capacitive or inductive operating element. The operating unit may comprise a multiplicity of operating elements, which are realized as electronic operating elements, and the respective actuation of which can be interrogated electronically, in particular sensed electronically and processed further electronically, by the electronic unit. It is also conceivable, however, for at least one of the operating elements to be realized as a mechanical operating element, the respective actuation of which can be interrogated electronically, in particular sensed electronically and processed further electronically, by the electronic unit, such as, for example, by means of at least one sensor element or the like.

The design according to the invention makes it possible, advantageously, to provide a system comprising a garden implement handle device that, in particular, provides a high degree of safety against a drive unit being put into operation unintentionally. Advantageously, a high degree of operator safety can be achieved. In addition, advantageously, a garden implement handle device that allows intuitive operation can be provided. Moreover, advantageously, it is possible to use operating elements that are designed for a low operating current, since switch-off currents of the operating elements can be low, and in particular do not have to correspond to a current that is flowing through the drive unit.

It is additionally proposed that the operating element and/or the further operating element extend/extends at least substantially fully along a circumferential extent of the garden implement handle device. Preferably, the operating element and/or the further operating element, realized as an electronic operating element realized so as to be touch-sensitive, extend/extends at least substantially fully along a circumferential extent of the garden implement handle device. Preferably, the operating element and/or the further operating element is realized, at least substantially, in the form of a rod. Particularly preferably, the operating element and/or the further operating element have/has a main extent that is substantially greater than a hand width. “At least substantially fully” in this context is to be understood to mean, in particular, by at least 50%, preferably by at least 70%, and particularly preferably by at least 90%. A “circumferential extent” in this context is to be understood to mean, in particular, an extent of the garden implement handle device in the circumferential direction, in particular perpendicular to a direction of main extent of the garden implement handle device. In addition, the operating element and/or the further operating element may be, at least partly, of an ergonomic shape, ergonomically activatable and/or covered with tactile surfaces. “Activatable” is to be understood here to mean emitting a user feedback such as, for example, vibrating and/or controlling of temperature. “Tactile surfaces” is to be understood to mean, in particular, a surface that improves friction and/or a surface that is roughened in end regions. It is thereby possible, advantageously, to achieve reliable and secure gripping and/or actuation of the operating element and/or the further operating element. Advantageously, a high degree of operator safety can be achieved. In addition, advantageously, a garden implement handle device that allows intuitive operation can be provided.

It is furthermore proposed that the at least one garden implement handle device has at least one handle on which the operating element is disposed and by means of which an orientation of the operating element relative to the further operating element can be altered. Preferably, the handle is realized so as to be swivelable. Particularly preferably, the handle is swivelable relative to a direction of main extent of the garden implement handle device. That “an orientation of the operating element relative to the further operating element can be altered” is to be understood in this context to mean, in particular, that an angle between a direction of main extent of the operating element and a direction of main extent of the further operating element can be altered, in particular by means of the handle. It is thereby possible, advantageously, to alter a grip posture of the garden implement handle device. Preferably, the grip posture of an operator can be adapted to a current operation. Particularly preferably, in this case the grip posture can be adapted, for example, to a position of the garden implement handle device required for operation and/or to an application requirement. In addition, advantageously, a garden implement handle device that allows intuitive operation can be provided.

It is additionally proposed that the at least one electronics unit has at least one timer, which is designed to monitor a duration of a switching state of the operating element and/or of the further operating element. Preferably the timer is designed to monitor, in at least one operating state, a duration of an absence of contact between an operator and the operating element and/or the further operating element. A “timer” in this context is to be understood to mean, in particular, an electronic time meter. Preferably, it is to be understood to mean, in particular, an electronic time meter that is integrated in an operating program of the electronics unit. It is thereby advantageously possible to monitor, for example, a duration of an absence of contact between an operator and the operating element and/or the further operating element. If, for example, the operating element and/or the further operating element are/is not touched over and beyond a certain period of time, the drive unit is automatically deactivated. In addition, it can thereby be achieved, in particular, that the drive unit is not automatically deactivated directly in the case of a change of grip. Thus, preferably, at least one a locking switching function or at least one dead-man's switching function can be activated in dependence on a duration. A “locking switching function” is to be understood here to mean, in particular, a function in which at least maintenance of an energy supply of the drive unit, following an actuation of the operating element and/or of the further operating element, is at least substantially independent of the operating element and/or the further operating element remaining actuated. The locking switching function is preferably designed to control electronically, by open-loop and/or closed-loop control, maintenance of the energy supply of a drive unit. The locking switching function and the functioning thereof are to be considered to be known, at least substantially, by persons skilled in the art. The term “dead-man's switching function” is intended here to define, in particular, a function in which, in particular, at least one energy supply of the drive unit can be prevented as a result of absence of an actuation of at least the operating element and/or of the further operating element. Preferably, the dead-man's switching function is designed to interrupt an energy supply of a drive unit as soon as the operating element and/or the further operating element are/is unactuated after an actuation has been effected, or an operator, after an actuation has been effected, removes a touch on the operating element and/or of the further operating element, in particular after expiry of a defined period of time. The dead-man's switching function and the functioning thereof are to be considered to be known, at least substantially, by persons skilled in the art. Advantageously, a system comprising a garden implement handle device that allows intuitive operation can be provided. In addition, advantageously, a high degree of operator safety can be achieved. In addition, it would also be conceivable for a duration between two actuations of the operating element and/or of the further operating element to be monitored by means of the timer. Thus, advantageously, safety functions can be realized in a simple manner.

It is further proposed that the system has at least one storage unit and, integrated in the at least one storage unit, at least one main switching element that is designed, at least, to activate and/or deactivate the operating element and/or the further operating element. A “storage unit” in this context is to be understood to mean, in particular, a unit by means of which the system or the garden implement handle device can be appropriately stowed for storage. Preferably, it is to be understood to mean, in particular, a unit by means of which the system or the garden implement handle device can be fastened, for example, to a wall, preferably to a hook and/or a screw, for the purpose of storage. Preferably, it is to be understood to mean, in particular, a unit that, when used, indicates storage. Particularly preferably, the storage unit is realized as a hanging hole. Quite particularly preferably, when the system is hung gravity acts upon the bearing unit in such a manner that the main switching element deactivates the operating element and/or at least the further operating element. Alternatively, however, it would also be conceivable for the storage unit to be realized as a pushbutton that is activated upon being placed on a base. In addition, an “integrated main switching element” in this context is to be understood to mean, in particular, a switching element that is coupled, at least, to the storage unit. Preferably, it is to be understood to mean, in particular, a switching element whose switching state is dependent on a state, in particular a state of use, of the storage unit. Particularly preferably, a switching state of the main switching element is defined by a use or non-use of the storage unit. A “main switching element” in this case is to be understood to mean, in particular, a switching element by means of which an energy supply can be disconnected from and/or connected to electronics. Preferably, it is to be understood to mean an operating switch. Thus, preferably, an appropriate automatic coupling of a storage state to an operating state can be achieved. Preferably, it can thus be achieved that the system or the garden implement handle device is automatically deactivated in a storage state. In particular, it is thus possible to dispense with manual deactivation. It can reliably be achieved that the system or the garden implement handle device, when stored, is not in a standby mode and/or in a working mode. Advantageously, a high degree of operator safety can be achieved. In addition, advantageously, a system comprising a garden implement handle device that allows intuitive operation can be provided.

It is additionally proposed that the system has at least one sensor unit that is connected to the at least one electronics unit and that has at least one force sensor, path sensor and/or speed sensor, for sensing a force exerted by an operator upon the garden implement handle device. Instead of the force sensor, path sensor and/or speed sensor, an alternative sensor, that senses an operator intention, may also be provided. Preferably, the force sensor senses, in at least one operating state, a force, in particular a pressure, exerted upon the operating element and/or the further operating element. For this purpose, the force sensor preferably senses a force acting upon the force sensor. Particularly preferably, an amount such as, in particular, a strength of a force acting upon the force sensor can be sensed by means of the force sensor. This makes it possible, preferably, to sense a force exerted upon the garden implement handle device by an operator. Preferably, an operating state and/or an operator intention can thereby be inferred. Particularly preferably, a speed of a drive unit can be controlled in dependence on a force exerted upon the garden implement handle device by an operator. Advantageously, a system comprising a garden implement handle device that allows intuitive operation can thereby be provided.

It is furthermore proposed that the system has at least one sensor unit that is connected to the at least one electronics unit and that has at least one acceleration sensor and/or position sensor for sensing a characteristic quantity of a movement and/or position of the garden implement handle device. Preferably, the acceleration and/or position sensor are/is designed to sense a movement range of the garden implement handle device. The acceleration and/or position sensor can be used to monitor, preferably, an orientation and/or change of orientation of the garden implement handle device. In particular, a risk of injury to an operator or other can thus be avoided. In particular, realization may be such that the garden implement handle device can be used only in a limited movement range. If, for example, the garden implement handle device is moved out of the safe movement range, injury can no longer be precluded and, in particular, the system is automatically deactivated. Alternatively, a warning signal, for example an acoustic, optical and/or tactile warning signal, could also be emitted. Moreover, it would also be conceivable for the system to be deactivated in the case of excessively rapid movements. It is thus advantageously possible to provide a system comprising a garden implement handle device that, in particular, has a particularly high degree of safety in the case of unforeseen movements of the garden implement handle device. Moreover, it is possible to provide a system that works only in a defined movement range, in particular in a preferred application angular range, and quite particularly preferably in a settable movement range. In addition, a system that works only in a defined position range can be provided. This may include, for example, overhead working by a user, or working close to a floor. In particular, this is intended to include all work positions between a work position, or orientation of the garden implement handle device, directed vertically toward a floor and/or a base and a work position directed vertically upward, as it were skywards. All operating positions, horizontal and vertical, are conceivable. Advantageously, a high degree of operator safety can be achieved.

It is additionally proposed that the electronics unit is designed to switch at least one function of the garden care machine that is other than an activation or deactivation of the energy supply of the drive unit, at least in dependence on a sensed operator movement on the operating element and/or the further operating element. Preferably, the electronics unit is designed to switch, in particular to activate or deactivate, at least one garden implement function, at least in dependence on a sensed operator movement on the operating element and/or the further operating element. A garden appliance function that is other than an activation or deactivation of the energy supply of the drive unit could be, for example, a locking switching function, a dead-man's switching function, a rotational-speed function or torque function of the drive unit, a working function (cutting height, cutting width, cutting speed, accelerating, braking, automatic cutting-line change, automatic cutting-line adjustment, advance speed, application angular range, position range or movement range, etc.), or another garden-implement function considered appropriate by persons skilled in the art. The operator movement effected on the operating element and/or the further operating element and, in particular, sensed by means of the electronics unit may be realized, for example, as a swipe movement, a tapping movement, a rotary movement, a relative movement of at least two fingers on the operating element and/or on the further operating element, as drawing of a symbol on the operating element and/or on the further operating element by means of at least one finger, or as another operator movement considered appropriate by persons skilled in the art. The electronic unit preferably has at least one evaluation unit, which is designed to evaluate an operator movement on the operating element and/or on the further operating element. Advantageously, convenient operation can be achieved by means of the design according to the invention.

Advantageously, the electronics unit is designed at least to switch, in particular to activate or deactivate, at least one garden implement function, in particular a garden implement function that is other than an activation or deactivation of the energy supply of the drive unit, at least in dependence on a gesture symbol effected on the operating element and/or the further operating element. The expression “effected gesture symbol” is intended here to define, in particular, a representation of a gesture that can be produced and/or represented on the operating element and/or the further operating element by at least one finger, by a plurality of fingers or by a hand, and/or that can be produced and/or represented as a result of at least one finger, a plurality of fingers or a hand being placed on the operating element and/or on the further operating element. For example, it is conceivable that, as a result of placing two fingers on the operating element and/or on the further operating element, an operator represents a gesture symbol for the number “2” on the operating element and/or the further operating element and, as a consequence, for example, the electronics unit switches an output unit into a second gear, sets a cutting height to level two, or the like. Other gesture symbols, effected to switch at least one garden implement function, that are considered appropriate by persons skilled in the art are likewise conceivable. The design according to the invention makes it possible, advantageously, to realize simple operation that, particularly advantageously, can be performed intuitively by an operator.

Preferably, the electronics unit has, in particular, at least one evaluation unit, which is designed, at least, to evaluate at least one surface characteristic quantity of the operating element and/or of the further operating element. Preferably, the evaluation unit is designed to evaluate a surface characteristic quantity of the operating element and/or of the further operating element that is realized as a size of a contact surface. Preferably, the evaluation is designed to evaluate a size of a contact surface of the operating element and/or of the further operating element that is covered by at least one finger, by a plurality of fingers or by a hand of an operator, relative to a total surface area of the operating element and/or of the further operating element. It is also conceivable, however, that the evaluation unit is additionally or alternatively designed to evaluate a surface characteristic quantity of the operating element and/or of the further operating element that is realized as surface pressure, or another surface characteristic quantity considered appropriate by persons skilled in the art. For example, it is conceivable that the electronics unit evaluates a turning of a hand on the operating element and/or on the further operating element appropriate to a movement in an actuation of a motor-cycle accelerator twist-grip throttle and, as a consequence, effects an increase or reduction of the rotational speed of the drive unit. Moreover, it is conceivable that pressing, in particular compressing, of the operating element and/or of the further operating element, in particular if the operating element and/or the further operating element are/is disposed along a large portion of a total circumferential extent of a handle element of the garden implement handle device that can be gripped by an operator, can be evaluated and, as a consequence, a braking function, which actively brakes the drive unit or a drive wheel, can be switched.

Advantageously, by means of the design according to the invention, for example a number of fingers placed on the operating element and/or on the further operating element by an operator, a magnitude of a holding force, or other surface characteristic quantities considered appropriate by persons skilled in the art can be evaluated. Particularly advantageously, a safe stoppage can be inferred. Thus, advantageously, a high degree of operator safety can be achieved. In addition, advantageously, as a result of an evaluation of the surface characteristic quantity of the operating element and/or of the further operating element, a function of the garden care machine can be operated, such as, for example, an alteration of a rotational speed of the drive unit in dependence on a size of a surface of the operating element and/or of the further operating element that is gripped or touched by an operator, or the evaluation can advantageously be taken into account by the electronics unit in the case of a switching of the energy supply of the drive unit, wherein, in particular, an activation of the energy supply of the drive unit can be prevented, in particular as long as a size of a surface of the operating element and/or of the further operating element that is gripped or touched by an operator is less than a limit value stored in the electronics unit.

It is proposed, preferably, that the system additionally comprises the garden care machine. Preferably, the garden care machine having the garden implement handle device is realized in the form of a rod. Preferably, the system is realized in the form of a rod. Particularly preferably, the garden care machine is realized as a motor-driven garden care machine. Preferably, the garden implement handle device has a drive unit, to which the garden care machine can be directly coupled. This would be conceivable, for example, if the system is realized as a lawn trimmer, hedge trimmer, power saw and/or as a pruning saw. It may also be applied, however, in a design as a rolling or mobile system, in particular a lawnmower or mulcher. The garden implement handle device may be disposed fixedly, preferably integrally, on the garden care machine, as well as separably connected to the garden care machine.

Also proposed is a procedure for operation of the system. Advantageously, the design according to the invention enables convenient operation of a garden care machine to be achieved. In addition, advantageously, intuitive operation of the system comprising the garden implement handle device can be provided.

It is furthermore proposed that, in at least one procedure step, at least one reaction of the electronics unit to an actuation of the operating element is effected in dependence on a touch-sensitive characteristic quantity of the further operating element. A high degree of safety can thus be achieved against the drive unit being put into operation unintentionally. Moreover, it is also possible to ensure that the garden implement is put into operation only as a result of being handled in a safe manner. Particularly preferably, the system, or the garden implement, can only be put into operation, or activated, as a result of an enabling operation. An “enabling operation” is to be understood to mean, for example, a movement effected on the operating element and/or the further operating element and, in particular, sensed by means of the electronics unit, and/or a gesture symbol effected on the operating element and/or the further operating element and, in particular, sensed by means of the electronics unit. A sensed movement may be realized, for example, as a swipe movement, a tapping movement, a rotary movement, a relative movement of at least two fingers on the operating element and/or on the further operating element, as drawing of a symbol on the operating element and/or on the further operating element by means of at least one finger, or as another operator movement considered appropriate by persons skilled in the art.

It is proposed, preferably, that, in at least one procedure step, at least one garden implement function, in particular a garden implement function that is other than an activation or deactivation of the energy supply of the drive unit, can be switched by means of the electronics unit in dependence on an actuation of an additional operating element, which is realized as an electronic operating element and which is movement-sensitive. Advantageously, convenient activation or deactivation of a garden implement function can be achieved.

It is furthermore proposed that, in at least one procedure step, the electronics unit effects an at least partly automatic switching of a function of the garden care machine in dependence of an actuation sequence of the operating element and/or of the further operating element. An “actuation sequence” is to be understood here to mean, in particular, an actuation of the operating element and/or of the further operating element that is time-defined or defined in respect of a sequence, such as, for example, a multiple actuation of the operating element and/or of the further operating element within a predefined time period, a defined sequence of an actuation of the operating element and/or of the further operating element, an actuation sequence of an actuation of the operating element and/or of the further operating element, in particular within a predefined time period, a preset duration of actuation of the operating element and/or of the further operating element, or the like. If an operator actuates the operating element and/or the further operating element, for example, at least twice in succession within a predefined time period and then actuates the further operating element or touches the further operating element during the multiple actuation of the operating element, an activation of the energy supply of the drive unit is effected. The predefined time period is, in particular, less than 20 seconds, preferably less than 10 seconds, and particularly preferably less than 5 seconds. Likewise conceivable are other actuations of the operating element and/or of the further operating element, at least for switching an energy supply of the drive unit or at least for activating/deactivating a garden implement function, that are considered appropriate by persons skilled in the art. Advantageously, intuitive operation of the system comprising the garden implement handle device can thereby be provided.

It is additionally proposed that, in at least one procedure step, the electronics unit, by means of the acceleration sensor and/or position sensor of the sensor unit, senses a movement or position of the garden implement handle device and activates or deactivates at least one function of the garden care machine in dependence on a characteristic quantity of a movement or position. Preferably, the one drive unit and/or the garden care machine are/is deactivated automatically in the case of an excessively large movement range and or in the case of an excessively high movement speed. Advantageously, the admissible movement range and/or the movement speed are/is dependent on the garden care machine used. For example, if a pruning saw is being used, the system allows a working orientation above a plane that is horizontal to the ground, but not, for example, in the case of a rake. Advantageously, a high degree of operator safety can thereby be achieved.

It is further proposed that, in at least one procedure step, the electronics unit activates or deactivates at least one function of the garden care machine if a duration of a switching state of the operating element and/or of the further operating element is exceeded. Advantageously, this makes it possible, for example, to monitor an absence of contact between an operator and the operating element and/or the further operating element. If, for example, the operating element and/or the further operating element are/is not touched over and beyond a certain period of time, a drive unit is automatically deactivated. In addition, it can thereby be achieved, in particular, that the drive unit is not automatically deactivated directly in the case of a change of grip, but a defined duration is provided and allowable for a change of grip. Advantageously, a high degree of operator safety can thereby be achieved. In addition, advantageously, intuitive operation of the system comprising the garden implement handle device can be provided.

It is additionally proposed that, in at least one procedure step, an at least partly automatic switching of a function of the garden care machine is effected in dependence on an actuation sequence of the operating element, in relation to a predefined time period. A high degree of safety, against the drive unit being put into operation unintentionally, can thus be achieved. Moreover, it is also possible to ensure that the garden care machine is put into operation only as a result of being handled in a safe manner. Advantageously, convenient activation or deactivation of a function of the garden care machine can be achieved.

The system according to the invention, the garden implement handle device according to the invention and/or the procedure according to the invention are/is not intended in this case to be limited to the application and embodiment described above. In particular, the system according to the invention, the garden implement handle device according to the invention and/or the procedure according to the invention may have individual elements, components and units, and procedure steps, that differ in number from a number stated herein, in order to fulfill a principle of function described herein. Moreover, in the case of the value ranges specified in this disclosure, values lying within the stated limits are also to be deemed as disclosed and applicable in any manner.

### DRAWING

Further advantages are disclosed by the following description of the drawing. Two exemplary embodiments are represented in the drawing. The drawing, the description and the claims contain numerous features in combination. Persons skilled in the art will also expediently consider the features individually and combine them to create appropriate further combinations.

There are shown in:

FIG. 1 a system according to the invention, comprising a garden implement handle device and comprising an electronics unit, and a garden care machine, in a schematic representation,

FIG. 2 the garden implement handle device of the system according to the invention, comprising an operating unit, which has an operating element that can be actuated by an operator, and which has a further operating element that can be actuated by an operator, in a schematic representation,

FIG. 3 the system according to the invention, comprising the garden implement handle device and comprising the electronics unit, the garden care machine and a movement range, in a schematic representation,

FIG. 4 a schematic flow diagram of operation of the system according to the invention, comprising the garden implement handle device and comprising the electronics unit,

FIG. 5 an alternative system according to the invention, comprising a garden implement handle device and comprising an electronics unit, and a garden care machine, in a schematic representation,

FIG. 6 a handle of the garden implement handle device of the alternative system according to the invention, in a first position, in a schematic representation,

FIG. 7 the handle of the garden implement handle device of the alternative system according to the invention, in a second position, in a schematic representation,

FIG. 8 a schematic flow diagram of operation of the alternative system according to the invention, comprising the garden implement handle device and comprising the electronics unit.

### DESCRIPTION OF THE EXEMPLARY EMBODIMENTS

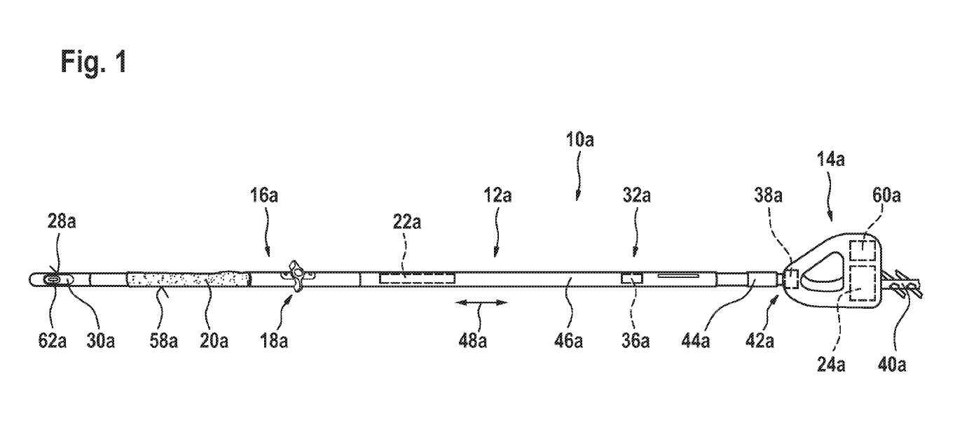

FIG. 1 shows a system 10a according to the invention, comprising a garden implement handle device 12a and comprising an electronics unit 22a. FIG. 1 additionally shows a garden care machine 14a. The garden care machine 14a is realized as a hedge trimmer. In principle, however, a different realization, considered appropriate by persons skilled in the art, would also be conceivable. The garden care machine 14a has a drive unit 24a. The drive unit 24a is constituted by an electric motor. The drive unit 24a is supplied with energy by a rechargeable battery, not shown further. The garden care machine 14a is realized as a separate appliance that can be coupled to the garden implement handle device 12a. In principle, the garden care machine 14a can also be used without the garden implement handle device 12a. In principle, however, it would also be conceivable for the garden care machine 14a to be realized as an attachment for the garden implement handle device 12a. The drive unit 24a and/or the rechargeable battery, which is not shown, may then, in particular, also be accommodated in the garden implement handle device 12a. For the purpose of coupling to the garden implement handle device 12a, the garden care machine 14a has a coupling connection 38a. The coupling connection 38a is designed to couple the garden care machine 14a both mechanically and electrically to the garden implement handle device 12a. In principle, however, it would also be conceivable for the garden care machine 14a to have two mutually separate coupling connections, for mechanical coupling and electrical coupling, respectively. The coupling connection 38a is disposed on a side of the garden care machine 14a that faces toward a working tool 40a of the garden care machine 14a.

The garden implement handle device 12a of the system 10a can be disposed on the garden care machine 14a. The garden implement handle device 12a can be disposed in a removable manner on the garden care machine 14a. The garden implement handle device 12a is disposed in a separable manner on the garden care machine 14a. The garden implement handle device 12a and the garden care machine 14a, when in a coupled state, are together realized in the form of a rod. The garden implement handle device 12a, when in a coupled state, is fixedly connected to the garden care machine 14a. For this purpose, the garden implement handle device 12a has a coupling connection 42a that corresponds to the coupling connection 38a of the garden care machine 14a. When in a coupled state, the coupling connection 42a of the garden implement handle device 12a latches, in a manner not shown further, with the coupling connection 38a of the garden care machine 14a. The coupling can be released in a non-destructive manner by drawing back a fixing sleeve 44a of the coupling connection 42a of the garden implement handle device 12a. The coupling connections 38a, 42a may also be realized in such a manner that they allow any angle and/or any rotation of the garden implement handle device 12a in relation to the garden care machine 14a.

The garden implement handle device 12a is realized as an extension rod. The garden implement handle device 12a has a rod-type main body 46a. The main body 46a has an approximately constant cross section along a direction of main extent 48a. The main body 46a is composed substantially of metal. In principle, however, a different material, considered appropriate by persons skilled in the art, could also be conceivable. The coupling connection 42a is disposed at an end of the basic body 46a that is at the front along the direction of main extent 48a. The coupling connection 42a directly adjoins the main body 46a.

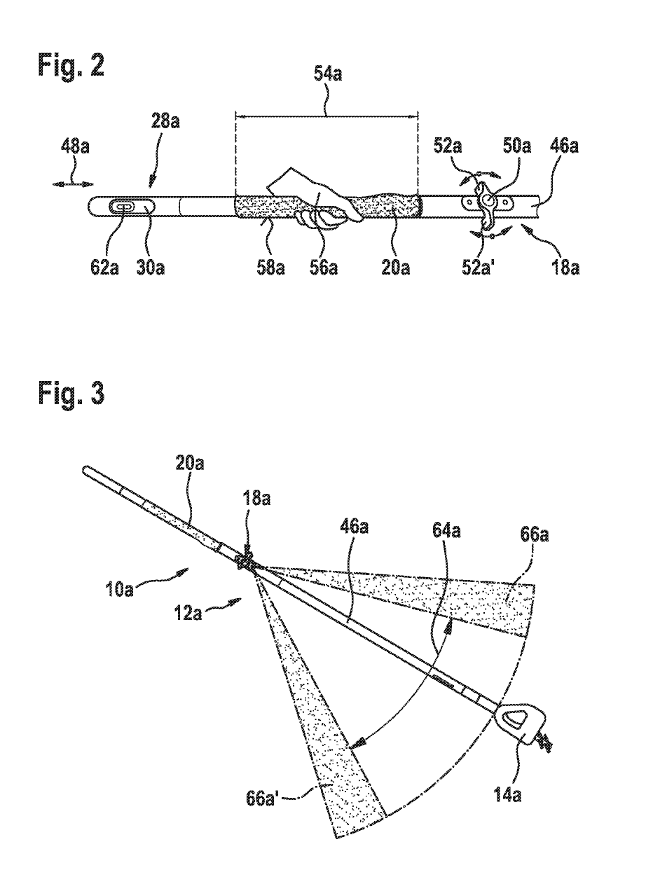

The garden implement handle device 12a additionally comprises an operating unit 16a. The operating unit 16a has an operating element 18a that can be actuated by an operator. The operating element 18a is realized as a rotary switch. The operating element 18a is disposed directly on the main body 46a. The operating element 18a is mounted so as to be rotatable. In addition, the operating element 18a has two actuating wings 52a, 52a′ projecting perpendicularly outward in opposite directions relative to a rotation axis 50a. The actuating wings 52a, 52a′ partly encompass the main body 46a. The operating element 18a can be displaced about the rotation axis 50a by means of the actuating wings 52a, 52a′. The operating element 18a has an initial position. In each of the figures, the operating element 18a is in an initial position. In an initial position, the actuating wings 52a, 52a′ project out from the rotation axis 50a, perpendicularly in relation to the direction of main extent 48a of the main body 46a. The operating element 18a additionally has a displacement position. In the displacement position, the operating element 18a is rotated in the circumferential direction about the rotation axis 50a by means of at least one of the actuating wings 52a, 52a′. The operating element 18a can be rotated by approximately 45°, relative to the initial position, in both possible directions of rotation. A direction of rotation in this case is not relevant. It can thereby be achieved, in particular, that the operating element 18a can be actuated with the same effect, irrespective of a position of the garden implement handle device 12a. The operating element 18a is spring-loaded. In the absence of applied force, the operating element 18a goes automatically from a displacement position to an initial position, and remains in the latter. The operating element 18a has a switching contact, not shown further. The switching contact can be switched as a result of an actuation of the operating element 18a. The switching contact of the further operating element 20a is designed to generate a switching signal, realized as an electrical characteristic quantity, in dependence on a displacement of the operating element 18a to a displacement position. Upon displacement of the operating element 18a to a displacement position, the switching contact generates an actuation switching signal (FIG. 2).

Furthermore, the operating unit 16a has a further operating element 20a that can be actuated by an operator. The further operating element 20a is realized as a grip region. The further operating element 20a is realized in the form of a rod. The further operating element 20a constitutes a grip surface 58a. In addition, the further operating element 20a extends fully along a circumferential extent of the garden implement handle device 12a. The further operating element 20a fully encompasses the main body 46a of the garden implement handle device 12a in the circumferential direction, perpendicularly in relation to the direction of main extent 48a. The further operating element 20a has a direction of main extent that is parallel to the direction of main extent 48a of the main body 46a. Parallel to the direction of main extent 48a of the main body 46a, the further operating element 20a has an extent 54a that is substantially greater than a hand width. In connection therewith, a hand 56a of the operator is represented in FIG. 2. It can thereby be achieved, in particular, that the further operating element 20a can be gripped in a variable manner. This makes it possible, in particular, to achieve a natural grip position. The further operating element 20a is realized as an electronic operating element that is realized so as to be touch-sensitive. By means of the further operating element 20a, a touch can be made by an operator, in particular by a hand 56a of the operator. For this purpose, the further operating element 20a has a switching contact, not shown further. The switching contact can be switched as a result of an actuation of the further operating element 20a. The switching contact of the further operating element 20a is designed to generate a switching signal, realized as an electrical characteristic quantity, in dependence on a touch on the further operating element 20a. Upon a touch on the further operating element 20a by a hand 56a of an operator, the switching contact generates an actuation switching signal (FIG. 2).

The system 10a additionally has an electronics unit 22a. The electronics unit 22a is realized as control electronics. The electronics unit 22a is disposed in the main body 46a of the garden implement handle device 12a. The electronics unit 22a constitutes a part of the garden implement handle device 12a. Alternatively, however, it would also be conceivable for the electronics unit 22a to constitute a part of an electronics unit 60a of the garden care machine 14a, and thus to be disposed in a housing of the garden care machine 14a. The electronics unit 22a is designed to switch at least one energy supply of the drive unit 24a in dependence on an actuation of the operating element 18a and of the further operating element 20a. An actuation of the operating element 18a and of the further operating element 20a can be interrogated and sensed electronically by means of the electronics unit 22a. For this purpose, the switching signals of the switching contacts of the operating element 18a and of the further operating element 20a are transmitted to the electronics unit 22a, and evaluated and processed further by the latter. When the garden implement handle device 12a has been coupled to the garden care machine 14a, the electronics unit 22a is connected to the electronics unit 60a of the garden care machine 14a via the coupling connections 38a, 42a. The electronics unit 22a of the system 10a is designed to operate the electronics unit 60a of the garden care machine 14a. The electronics unit 22a of the system 10a can operate the drive unit 24a of the garden care machine 14a via the electronics unit 60a of the garden care machine 14a. In addition, when in a coupled state, the electronics unit 22a is supplied with energy via the rechargeable battery of the garden care machine 14a. The system 10a, when in a coupled state, is supplied with energy via the rechargeable battery of the garden care machine 14a, via the coupling connections 38a, 42a. In principle, however, it would also be conceivable for the system 10a, or the garden implement handle device 12a, to have its own integrated rechargeable battery.

The electronics unit 22a is additionally designed to switch at least one function of the garden care machine 14a that is other than an activation or deactivation of the energy supply of the drive unit 24a, at least in dependence on a sensed operator movement on the further operating element 20a. For example, a speed of the drive unit 24a may be altered, in dependence on a direction of rotation, by a rotary movement of the hand 56a of the operator in the circumferential direction on the grip surface 58a of the further operating element 20a. In principle, however, other operator movements, considered appropriate by persons skilled in the art, are also conceivable.

The electronics unit 22a has a timer. The timer is designed to monitor a duration of a switching state of the operating element 18a and of the further operating element 20a. For this purpose, a duration of a switching signal of the switching contacts of the operating element 18a and of the further operating element 20a is monitored by the electronics unit 22a. During operation, the electronics unit 22a monitors both a duration of an actuation switching signal and a duration of an absence of an actuation switching signal.

The system 10a additionally has a sensor unit 32a, which is connected to the electronics unit 22a. The sensor unit 32a has an acceleration and/or position sensor 36a. The acceleration sensor and/or position sensor 36a are/is connected, in a manner not shown further, to the electronics unit 22a. The acceleration sensor and/or position sensor 36a are/is disposed in the main body 46a of the garden implement handle device 12a. The acceleration sensor and/or position sensor 36a are/is disposed in a front region of the main body 46a that faces toward the coupling connection 42 of the garden implement handle device 12a. In addition, the acceleration sensor and/or position sensor 36a are/is designed to sense a characteristic quantity of a movement and/or position of the garden implement handle device 12a. The acceleration sensor and/or position sensor 36a are/is designed, when in operation, to sense a movement range of the garden implement handle device 12a, in particular of a front region of the garden implement handle device 12a that faces toward the coupling connection 42. In addition, the acceleration sensor and/or position sensor 36a are/is designed to sense a movement speed of the garden implement handle device 12a. The acceleration sensor and/or position sensor 36a, when in operation, sense/senses a movement speed of a front region of the garden implement handle device 12a that faces toward the coupling connection 42.

Furthermore, the system 10a has a storage unit 28a. The storage unit 28a constitutes a part of the garden implement handle device 12a. The storage unit 28a is disposed at and end of the base body 46a that is at the rear along the direction of main extent 48a. The storage unit 28a is disposed on the basic body 46a, at an end of the basic body 46a that faces away from the coupling connection 42a. The storage unit 28a directly adjoins the main body 46a. The storage unit 28a serves to suspend the garden implement handle device 12a. The storage unit 28a has an opening 62a. In the case of storage, a screw and/or a hook, in particular attached to a wall, can be passed through the opening 62a. The opening 62a extends, perpendicularly in relation to the direction of main extent 48a of the main body 46a, through the garden implement handle device 12a (FIG. 2).

The system 10a additionally has a main switching element 30a, which is integrated in the storage unit 28a. The main switching element 30a is realized as an operating switch. The main switching element 30a is designed, at least, to activate and deactivate the operating element 18a and the further operating element 20a. The main switching element 30a is designed to activate and deactivate the entire system 10a. By means of the main switching element 30a, an energy supply can be inhibited or enabled. The main switching element 30a is integrated into the storage unit 28a. The main switching element 30a is realized so as to be partly movable relative to the main body 46a. The main switching element 30a delimits the opening 62a of the storage unit 28a. Via the main switching element 30a, the opening 62a is likewise realized so as to be partly movable relative to the main body 46a. The opening 62a can be displaced to a limited extent relative to the main body 46a, parallel to the direction of main extent 48a of the main body 46a. A position of the opening 62a relative to the main body 46a in this case defines a switching position of the main switching element 30a. Displacing of the opening 62a causes a switching position of the main switching element 30a to be altered. The main switching element 30a has two switching positions. If the opening 62a is in a position that is maximally distant from the main body 46a, as represented in the figures, the main switching element 30a is in an inactive switching position. In the inactive switching position of the main switching element 30a, an energy supply of the system 10a is enabled. If, on the other hand, the opening 62a is in a position that is maximally close to the main body 46a, the main switching element 30a is in an active switching position. In the active switching position of the main switching element 30a, an energy supply of the system 10a is enabled. In a storage state, i.e. in a state in which the system 10a is suspended, the opening 62a is brought automatically by gravity, which draws the main body 46a downward, and by a force of a screw and/or a hook that is passed through the opening 62a, into a position that is maximally distant from the main body 46. As a result, when the system 10a is in a storage state, the main switching element 30a is brought automatically into an inactive switching position. It is thereby possible to prevent the system 10a from being in an active or standby state during storage, and to prevent the possibility of unintentional starting of the drive unit 24a (FIG. 2).

A procedure for operation and use of the system 10a is described in the following. In the procedure, the electronics unit 22a reacts, in some procedure steps, to an actuation of the operating element 18a, in dependence on a touch-sensitive characteristic quantity of the further operating element 20a. In addition, the electronics unit 22a effects a partly automatic switching of a function of the garden care machine 14a in dependence on an actuation sequence of the operating element 18a or of the further operating element 20a. Furthermore, if a duration of a switching state of the operating element 18a or of the further operating element 20a of the garden implement handle device 12a is exceeded, the electronics unit 22a activates or deactivates at least one function of the garden care machine 14a.

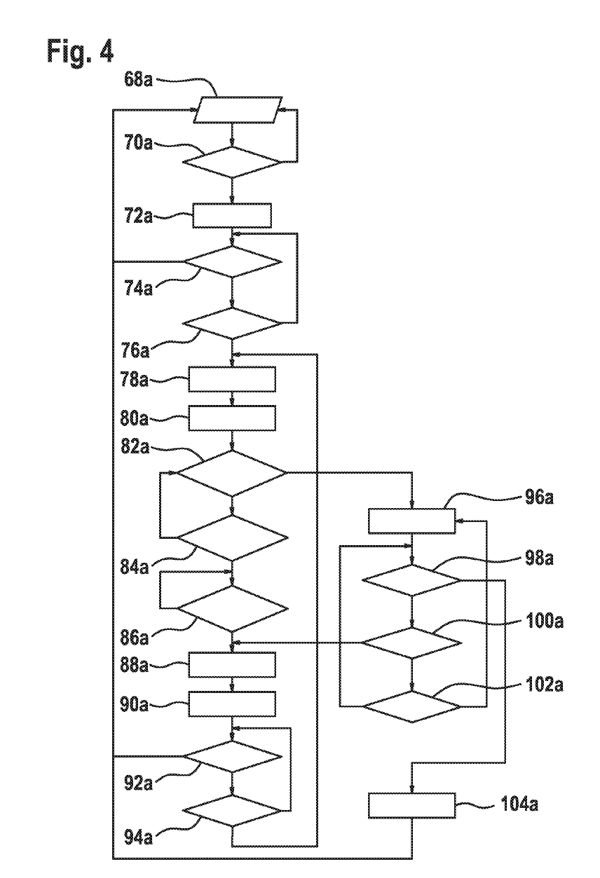

For operation of the system 10a, the main switching element 30a must be in an active switching position. If the main switching element 30a is in an inactive switching position, such as, for example, following storage, the main switching element 30a must be brought manually into an active switching position, by drawing down of the opening 62a. When the main switching element 30a is in an active switching position, in order for the drive unit 24a to be activated it is necessary, inter alia, for the further operating element 20a to be touched, in particular gripped, by an operator. Therefore, in the case of the drive unit 24a being deactivated and in the absence of a touch on the further operating element 20a, it is indicated in an output 68a to an operator, in a manner not shown further, that the further operating element 20a must be touched. In principle, however, it would also be conceivable to dispense with a corresponding output 68a. In this state, in a step 70a, a switching signal of the further operating element 20a is continuously checked by the electronics unit 22a. If there is no switching signal present, or there is a 0 switching signal, the output 68a is maintained. If a switching signal, or a 1 switching signal, is present, it can be inferred that the further operating element 20a is being touched, in particular gripped, by an operator, and, in a further step 72a, the timer is reset by the electronics unit 22a. Then, in a further step 74a, a value of the timer is checked by the electronics unit 22a. Within the first five seconds a switching signal of the operating element 18a is checked, in a further step 76a. If the operating element 18a is not actuated, the timer and the switching signal continue to be checked. If, on the other hand, the operating element 18a is actuated within the five seconds of the timer, the drive unit 24a is started, in a further step 78a. If the five seconds of the timer are exceeded without a switching signal, the procedure starts from the beginning. Following the starting of the drive unit 24a, the timer is reset in a further step 80a. Then, in a further step 82a, a switching signal of the operating element 18a is checked (FIG. 4).

If the operating element 18a is actuated, in a subsequent step 84a a value of the timer is checked. If the value of the timer is less than 0.7 seconds, the switching signal of the operating element 18a is checked again, in the step 82a. If the value is greater than 0.7 seconds, it can be assumed therefrom that the operating element 18a is deliberately being kept pressed down. If this is the case, it is assumed therefrom that the system 10a is being operated in that the operating element 18a is kept pressed down. In a further step 86a, therefore, it is only checked whether the operating element 18a is being kept pressed down. If the operating element 18a is released by an operator, the drive unit 24a is stopped in a step 88a. Following a stoppage of the motor, the timer is reset in a step 90a. If the operating element 18a is pressed again within three seconds, the drive unit 24a restarts directly. For this purpose, a value of the timer is checked in a step 92a. As long as this value remains under three seconds, it is checked, in a step 94a, whether the operating element 18a is actuated. If the operating element 18a is actuated within this time, the operation is continued with the step 78a, and the drive unit 24a is restarted. If, on the other hand, in the step 92a, the value of 3 seconds is exceeded, the procedure starts from the beginning.

If, in the step 82a, the operating element 18a is not actuated, the timer is again reset, in a step 96. In this case, it is assumed that the system 10a is to be operated by holding of the further operating element 20a. Therefore, in a subsequent step 98a, a value of the timer is checked. If the value of the timer is less than five seconds, the switching signal of the operating element 18a is checked in the step 100a. If the operating element 18a is actuated within this time, the operation is continued with the step 88a and the drive unit 24a is stopped. If the operating element 18a is not actuated, a switching signal of the further operating element 20a is checked in a step 102a. If, in this period, the further operating element 20a is touched or held by the operator, the operation is continued with the step 96a and the timer is reset. The further operating element 20a can thus also be released for a short time during operation without stoppage of the drive unit 24a. If, on the other hand, the period of five seconds is exceeded, the drive unit 24a is stopped in a further step 104, and the procedure restarts from the beginning.

Operation of the system 10a can therefore be realized in two ways. It can be operated both by keeping the operating element 18a actuated and by holding of the further operating element 20a. For the purpose of starting the drive unit 24a, however, it is necessary both to grip the further operating element 20a and to actuate the operating element 18a, at least briefly. It can thus be ensured that starting of the drive unit 24a is wanted.

During operation, in particular when the drive unit 24a is activated, the electronics unit 22a, by means of the acceleration sensor and/or position sensor 36a of the sensor unit 32a, senses a movement and/or position of the garden implement handle device 12a. The electronics unit 22a activates or deactivates a function of the garden care machine 14a in dependence on a characteristic quantity of a movement and/or position. The electronics unit 22a in this case monitors a movement range and/or position range of the garden implement handle device 12a. The garden implement handle device 12a in this case may be moved only within a defined angular range 64a. If the garden implement handle device 12a is moved beyond the angular range 64a into a limit range 66a, 66a′, the electronics unit 22a automatically deactivates the drive unit 24a. Moreover, the electronics unit 22a additionally monitors a movement speed of the garden implement handle device 12a. If the garden implement handle device 12a is moved too rapidly, the electronics unit 22a likewise automatically deactivates the drive unit 24a. A risk of injury resulting from unintentional, in particular hectic, movements can thus be minimized (FIG. 3).

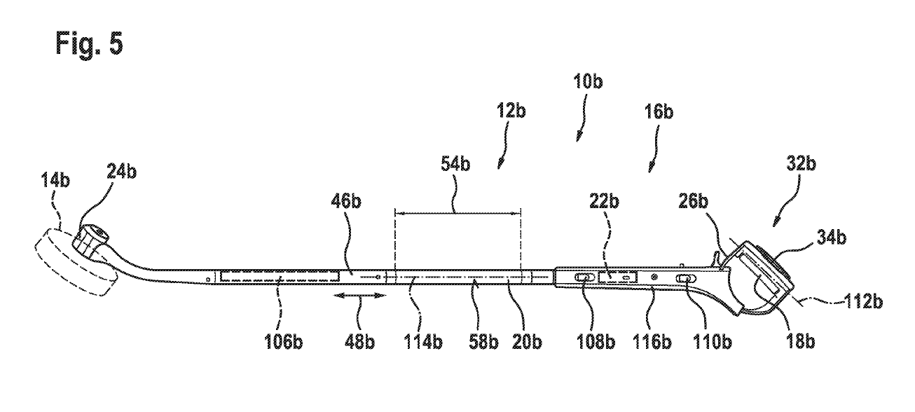

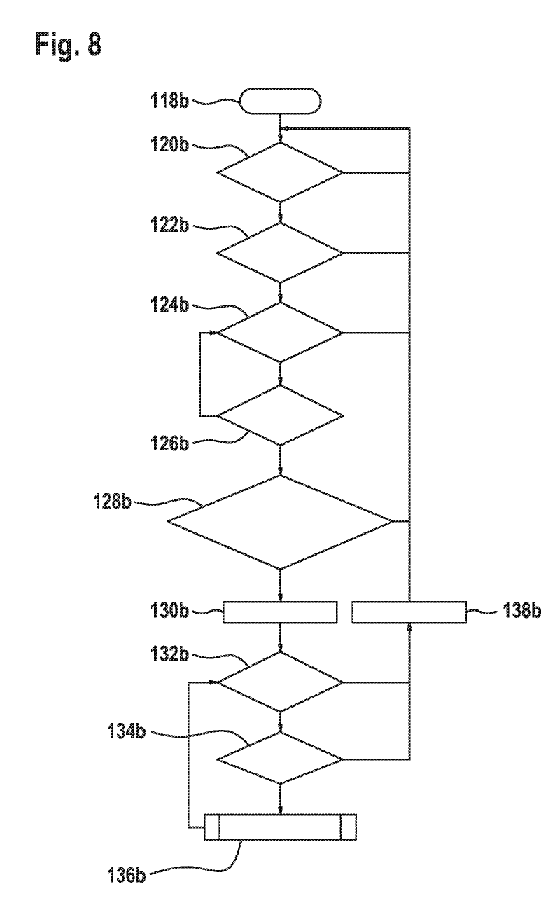

A further exemplary embodiment of the invention is shown in FIGS. 5 to 8. The descriptions and the drawings that follow are limited substantially to the differences between the exemplary embodiments, and in principle reference may also be made to the drawings and/or the description of the exemplary embodiment of FIGS. 1 to 4 in respect of components that have the same designation, in particular in respect of components denoted by the same references. To distinguish the exemplary embodiments, the letter a has been appended to the references of the exemplary embodiment in FIGS. 1 to 4. In the exemplary embodiments of FIGS. 5 to 8, the letter a has been replaced by the letter b.

FIG. 5 shows an alternative system 10b according to the invention, comprising a garden implement handle device 12b and comprising an electronics unit 22b. FIG. 5 additionally shows a garden care machine 14b. The garden care machine 14b, together with the garden implement handle device 12b, is realized as a lawn trimmer. In principle, however, a different realization, considered appropriate by persons skilled in the art, would also be conceivable.

The garden implement handle device 12b has a drive unit 24b. The garden care machine 14b is directly coupled to the drive unit 24b, in a manner not shown further. For the purpose of transmission of a rotational motion, the garden care machine 14b is mechanically coupled to the drive unit 24b, in a manner not shown further. The drive unit 24b is constituted by an electric motor. The garden care machine 14b is removably connected to the drive unit 24b. The garden implement handle device 12b of the system 10b can be disposed on the garden care machine 14b. The garden care machine 14b is realized as an attachment for the garden implement handle device 12b. The garden implement handle device 12b and the garden care machine 14b, when in a coupled state, are together realized in the form of a rod. The garden implement handle device 12b is likewise realized in the form of a rod. The garden implement handle device 12b has a rod-type main body 46b. The main body 46b has an approximately constant cross section along a main direction of extent 48b. The main body 46b is composed substantially of metal. In principle, however, a different material, considered appropriate by persons skilled in the art, would also be conceivable. The drive unit 24b is disposed at an end of the main body 46b that is at the front along the direction of main extent 48b. The drive unit 24b directly adjoins the main body 46b. The drive unit 24b is supplied with energy by a rechargeable battery 106b. The rechargeable battery 106b is disposed in the main body 46b. The rechargeable battery 106b is integrated into the main body 46b.

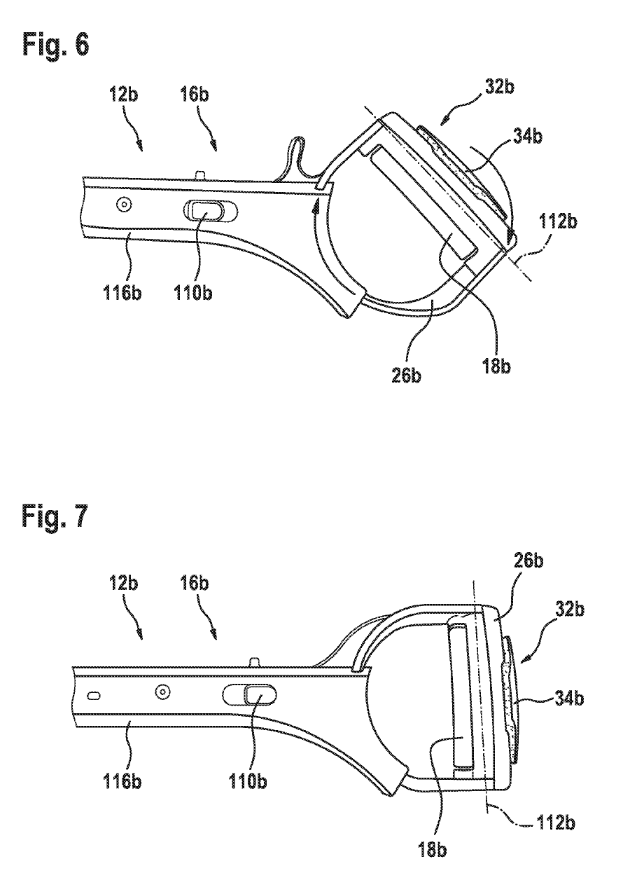

The garden implement handle device 12b additionally comprises an operating unit 16b. The operating unit 16b has an operating element 18b that can be actuated by an operator. The operating element 18b is realized as a pushbutton switch. The operating element 18b is disposed on a handle 26b of the garden implement handle device 12b. The handle 26b is realized in a D shape. In principle, however, a different shape, considered appropriate by persons skilled in the art, would also be conceivable. The handle 26b is disposed on side of the garden implement handle device 12b that faces away from the drive unit 24b. The handle 26b is disposed at an end of the garden implement handle device 12b that faces away from the drive unit 24b. The operating element 18b is disposed on a straight side of the D-shaped handle 26b. The operating element 18b extends approximately entirely over a width of the handle 26b. In addition, the operating element 18b is disposed on an inside of the D-shaped handle 26b. The operating element 18b has a switching contact, not shown further. The switching contact can be switched as a result of an actuation of the operating element 18b. The switching contact of the further operating element 20a is designed to generate a switching signal, realized as an electrical characteristic quantity, in dependence on a pressing on the operating element 18b. Upon a pressing on the operating element 18b, the switching contact generates an actuation switching signal (FIG. 6).

Furthermore, the operating unit 16b has a further operating element 20b that can be actuated by an operator. The further operating element 20b is realized as a grip region. The further operating element 20b is realized in the form of a rod. The further operating element 20b constitutes a grip surface 58b. In addition, the further operating element 20b extends fully along a circumferential extent of the garden implement handle device 12b. The further operating element 20b fully encompasses the main body 46b of the garden implement handle device 12b in the circumferential direction, perpendicularly in relation to the direction of main extent 48b (FIG. 5).

By means of the handle 26b, an orientation of the operating element 18b relative to the further operating element 20b can be altered. The handle 26b is disposed on an electronics housing 116b. The electronics housing 116b directly adjoins the main body 46b. The electronics housing 116b adjoins the main body 46b on a aide that faces toward the drive unit 24b. The electronics housing 116b accommodates at least some electronics of the system 10b. The handle 26b is realized so as to be swivelable relative to the electronics housing 116b. The handle 26b can be swiveled relative to the direction of main extent 48b of the main body 46b. For this purpose, a convex side of the D-shaped handle 26b is located in the electronics housing 116b and can be rotated along this side. Integrated in the electronics housing 116b is a fixing mechanism, not shown further, by means of which a rotary position of the handle 26b can be fixed. The fixing mechanism can be released by means of a fixing switch 110b disposed on the electronics housing 116b. The fixing switch 110b is spring-loaded, such that, in the case of non-actuation, it moves automatically into a fixing position. FIG. 7 shows a fixing position of the fixing switch 110b. FIG. 6 shows a release position of the fixing switch 110b. In a release position of the fixing switch 110b, the handle 26b can be rotated within a limited angular range. This advantageously enables a grip posture of the garden implement handle device 12b to be altered. Rotation of the handle 26b additionally results in rotation of a grip axis 112b of the operating element 18b relative to a grip axis 114b of the further operating element 20b (FIG. 6, 7).

The system 10b additionally has an electronics unit 22b. The electronics unit 22b is realized as control electronics. The electronics unit 22b is disposed in the electronics housing 116b of the garden implement handle device 12b. The electronics unit 22b is designed to switch at least one energy supply of the drive unit 24b in dependence on an actuation of the operating element 18b and of the further operating element 20b.

The system 10b additionally as a sensor unit 32b, which is connected to the electronics unit 22b. The sensor unit 32b has a force sensor, path sensor and/or movement speed sensor 34b. The force sensor, path sensor and/or movement speed sensor 34b are/is connected to the electronics unit 22b, in a manner not shown further. The force sensor, path sensor and/or movement speed sensor 34b are/is disposed on the handle 26b of the garden implement handle device 12b. The force sensor, path sensor and/or movement speed sensor 34b are/is disposed on a side of the straight side of the handle 26b that faces away from the operating element 18b. The force sensor, path sensor and/or movement speed sensor 34b are/is designed to sense a force, movement path and/or movement speed exerted by an operator upon the garden implement handle device 12b. The force sensor 34b senses both a force with which an operator presses the operating element 18b, and a force that an operator to the garden implement handle device 12b as a whole. By means of the force sensor, path sensor and/or movement speed sensor 34b, a speed and/or a torque of the drive unit 24b can be controlled. A speed and/or a torque of the drive unit 24b are/is controlled by the electronics unit 22b in dependence on a force, movement path and/or movement speed exerted upon the force sensor, path sensor and/or movement speed sensor 34b.

The garden implement handle device 12b additionally has an operating switch 108b. The operating switch 108b is disposed on the electronics housing 116b. The operating switch 108b is designed, at least, to activate and deactivate the operating element 18b and the further operating element 20b. The operating switch 108b is designed to activate and deactivate the entire system 10b. By means of the operating switch 108b, an energy supply of the rechargeable battery 106b can be inhibited or enabled. The operating switch 108b is realized as a slide switch (FIG. 5).

A procedure for operation and use of the system 10b is described in the following. In the procedure, the electronics unit 22b reacts, in some procedure steps, to an actuation of the operating element 18b, in dependence on a touch-sensitive characteristic quantity of the further operating element 20b. In addition, the electronics unit 22b effects a partly automatic switching of a function of the garden care machine 14b in dependence on an actuation sequence of the operating element 18b or of the further operating element 20b. Furthermore, in one procedure step, an at least partly automatic switching of a function of the garden care machine 14b is effected in dependence on an actuation sequence of the operating element 18b, in relation to a predefined time period.

For operation of the system 10b, the operating switch 108b must be in an active switching position. In an active switching position of the operating switch 108b, the procedure is started with a start 118b. Following the start 118b, a switching signal of the further operating element 20b is checked in a further step 120b. If the further operating element 20b is not gripped by an operator, the procedure starts from the beginning. If the further operating element 20b is gripped by an operator, a switching signal of the operating element 18b is checked in a subsequent step 122b. If the operating element 18b is not pressed, the procedure starts from the beginning. If the operating element 18b is pressed by an operator, a switching signal of the further operating element 20b is checked again, in a further step 124b. If the further operating element 20b is not gripped by an operator, the procedure starts from the beginning. If the further operating element 20b is still gripped by an operator, it is checked, in a subsequent step 126b, whether the operating element 18b has been released again. If the operating element 18b is still being pressed, step 124b is repeated. If the operating element 18b has been released, it is checked, in a further step 128b, whether the further operating element 20b is continuously gripped by an operator and whether the operating element 18b is pressed again within two seconds. In this case, an automatic switching of a function of the garden care machine 14b is effected in dependence on an actuation sequence of the operating element 18b, in relation to a predefined time period. If this is not the case, the procedures starts from the beginning. If both conditions are fulfilled, the drive unit 24b is started in a subsequent step 130b. Then, in the steps 132b and 134b, it is checked whether the further operating element 20b is gripped by an operator and the operating element 18b is pressed by an operator. If the operating element 18b or the further operating element 20b is released, the drive unit 24b is stopped in a subsequent step 138b, and the procedure starts from the beginning. If the operating element 18b is pressed by an operator and the further operating element 20b is gripped by an operator, a speed and/or a torque of the drive unit 24b is controlled, via a subroutine 136b, by means of the force sensor, path sensor and/or movement speed sensor 34b. A speed and/or a torque of the drive unit 24b is controlled by the electronics unit 22b in dependence on a force, movement path and/or movement speed exerted upon the force sensor, path sensor and/or movement speed sensor 34b.

1. A system comprising:
at least one garden implement handle device disposed on a garden care machine, the at least one garden implement handle device including:
at least one operating unit having:
at least one operating element configured for actuation by an operator; and
at least one further operating element configured for actuation by the operator;
at least one electronics unit configured to switch at least one energy supply of a drive unit based on an actuation of the at least one operating element and an actuation of the at least one further operating element,
wherein the at least one operating element and/or the at least one further operating element are/is a touch-sensitive electronic operating element.

2. The system as claimed in claim 1, wherein the at least one operating element and/or the at least one further operating element extend/extends at least substantially fully along a circumferential extent of the at least one garden implement handle device.

3. The system as claimed in claim 1, wherein the at least one garden implement handle device further includes:
at least one handle on which the at least one operating element is disposed and the at least one handle is configured to alter an orientation of the at least one operating element relative to the further operating element.

4. The system as claimed in claim 1, wherein the at least one electronics unit includes at least one timer configured to monitor a duration of a switching state of the at least one operating element and/or of the at least one further operating element.

5. The system as claimed in claim 1, further comprising:
at least one storage unit,
wherein at least one main switching element is integrated in the at least one storage unit and the at least one main switching element is configured to activate and/or deactivate the at least one operating element and/or the at least one further operating element.

6. The system as claimed in claim 1, further comprising:
at least one sensor unit connected to the at least one electronics unit, the at least one sensor unit including at least one force sensor, path sensor and/or speed sensor to sense a force exerted by an operator upon the garden implement handle device.

7. The system as claimed in claim 1, further comprising:
at least one sensor unit connected to the at least one electronics unit, the at least one sensor unit including at least one acceleration sensor and/or position sensor to sense a characteristic quantity of a movement and/or position of the garden implement handle device.

8. The system as claimed in claim 1, wherein the at least one electronics unit is configured to switch at least one function of the garden care machine other than an activation or deactivation of the energy supply of the drive unit based on a sensed operator movement on the at least one operating element and/or the at least one further operating element.

9. A garden implement handle device of a system comprising:
at least one operating unit having:
at least one operating element configured for actuation by an operator; and
at least one further operating element configured for actuation by the operator; and
at least one electronics unit configured to switch at least one energy supply of a drive unit based on an actuation of the at least one operating element and an actuation of the at least one further operating element,
wherein the garden implement handle device is disposed on a garden care machine, and
wherein the at least one operating element and/or the at least one further operating element are/is a touch-sensitive electronic operating element.

10. A method for operation of an electronic system, comprising:
switching at least one energy supply of a drive unit using at least one electronics unit based on an actuation of at least one operating element and an actuation of at least one further operating element,
wherein the at least one operating element and the at least one further operating element are included in at least one operating unit and the at least one operating element is configured for actuation by an operator and the at least one further operating element is configured for actuation by the operator,
wherein the at least one operating element and/or the at least one further operating element are/is a touch-sensitive electronic operating element,
wherein the at least one operating unit is included in at least one garden implement handle device disposed on a garden care machine, and
wherein the at least one garden handle device is included in the system.

11. The method as claimed in claim 10, further comprising:
effecting at least one reaction of the electronics unit to an actuation of the at least one operating element based on a touch-sensitive characteristic quantity of the at least one further operating element.

12. The method as claimed in claim 10 further comprising:
effecting an at least partly automatic switching of a function of the garden care machine using the electronics unit based on an actuation sequence of the operating element and/or of the further operating element.

13. The method as claimed in claim 10, further comprising:
sensing a movement or position of the garden implement handle device using the electronics unit via an acceleration sensor and/or position sensor of a sensor unit; and
activating or deactivating at least one function of the garden care machine using the electronics unit based on a characteristic quantity of a movement or position.

14. The method as claimed in claim 10, further comprising:
activating or deactivating at least one function of the garden care machine using the electronics unit if a duration of a switching state of the operating element and/or of the further operating element is exceeded.

15. The method as claimed in claim 10, further comprising:
effecting an at least partly automatic switching of a function of the garden care machine based on an actuation sequence of the operating element, in relation to a predefined time period.
